(19) United States
(12) Patent Application Publication
(10) Pub. No.: US 2022/0113916 A1
(43) Pub. Date: Apr. 14, 2022

(54) IMAGE FORMING APPARATUS AND STORAGE MEDIUM

(71) Applicant: Konica Minolta, Inc., Tokyo (JP)

(72) Inventor: Masayuki Yasukaga, Tokyo (JP)

(73) Assignee: Konica Minolta, Inc., Tokyo (JP)

(21) Appl. No.: 17/450,768

(22) Filed: Oct. 13, 2021

(30) Foreign Application Priority Data
Oct. 14, 2020 (JP) 2020-173053

(51) Int. Cl. G06F 3/12

(52) U.S. Cl. CPC G06F 3/1205; G06F 3/1237; G06F 3/1284

(57) ABSTRACT

An image forming apparatus includes: an image former that forms an image on a sheet; and a hardware processor that: generates, based on setting information of post processing performed on the sheet, adjustment image data that includes identification information identifying each of a plurality of adjustment items of the post processing; and causes the image former to form, based on the adjustment image data, an adjustment image on the sheet.

### CROSS-REFERENCE TO RELATED APPLICATIONS

The entire disclosure of Japanese Patent Application No. 2020-173053 filed on Oct. 14, 2020 is incorporated herein by reference.

### BACKGROUND

### Technical Field

The present invention relates to an image forming apparatus and a storage medium.

### Description of the Related Art

The image forming apparatus enables various processes of post processing such as stapling, punching and cutting, by connecting finisher options. The contents of the processes of post processing are generally set to the print job.

In the above image forming apparatus, when the proof printing function is used to the print job to which the post processing was set, the set post processing is performed to the outputted product.

There is also known a system which includes a bulk specifying means for specifying multiple post processing methods in bulk in a trial post processing setting UI screen when a trial post processing mode is set, and which can perform multiple trial printing and trial post processing by once performing the setting without repeatedly performing the sequence of “setting, printing and then post processing” (see JP 2008-152472 A).

In JP 2008-152472 A, the post processing is actually performed for a trial. However, when the cutting is set and the cutting is actually performed in the post processing, for example, the user does not know where the cut piece was originally located (was it at the top right or bottom left of the paper before cutting, etc.). Thus, it may be difficult to check the quality of post-processing after performing fine adjustment.

The above matters are further difficult to know particularly when the post processing setting has many setting items of position adjustment.

### SUMMARY

One or more embodiments of the present invention provide an image forming apparatus and a storage medium storing a program that can facilitate checking adjustment results to the post processing, and facilitate adjustment.

An image forming apparatus reflecting one aspect of the present invention is an image forming apparatus including a hardware processor that: generates adjustment image data including identification information for individually identifying multiple adjustment items to post processing performed on a sheet based on setting information of the post processing; and causes an image former to form an adjustment image based on the adjustment image data on the sheet.

A storage medium reflecting one aspect of the present invention is a non-transitory computer readable storage medium storing a program that causes a computer of an image forming apparatus including an image former which forms an image on a sheet to execute: data generating that is generating adjustment image data including identification information for individually identifying multiple adjustment items to post processing performed on the sheet based on setting information of the post processing; and controlling that is causing the image former to form an adjustment image based on the adjustment image data on the sheet.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram showing a schematic configuration of an image forming system;

FIG. 2 is a functional block diagram showing a control structure of the image forming system;

FIG. 3 is the processing flow of an image forming apparatus 1;

FIG. 4 is a view showing an example of a post processing position adjustment screen at the time of cutting the sheet into two pieces;

FIG. 5 is a specific example (Example 1) of a preview image of a cutting position at the time of cutting the sheet into two pieces;

FIG. 6 is a view showing an example of a profile creation screen at the time of cutting the sheet into two pieces;

FIG. 7 is a specific example (Example 2) of a preview image of a cutting position at the time of cutting the sheet into two pieces;

FIG. 8 is a specific example (Example 3) of a preview image of a cutting position at the time of cutting the sheet into two pieces; and

FIG. 9 is a specific example (Example 4) of a preview image of a cutting position at the time of cutting the sheet into two pieces.

### DETAILED DESCRIPTION OF EMBODIMENTS

Hereinafter, embodiments of the present invention will be described in detail with reference to the drawings. However, the scope of the invention is not limited to the disclosed embodiments or the illustrated examples.

[Configuration]

The configuration of an image forming apparatus 1 according to one or more embodiments will be described first.

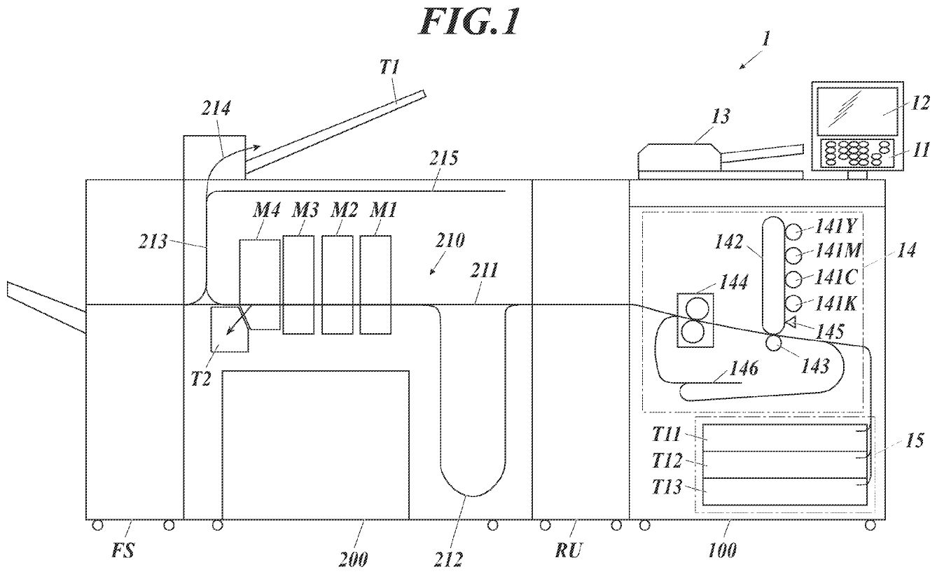

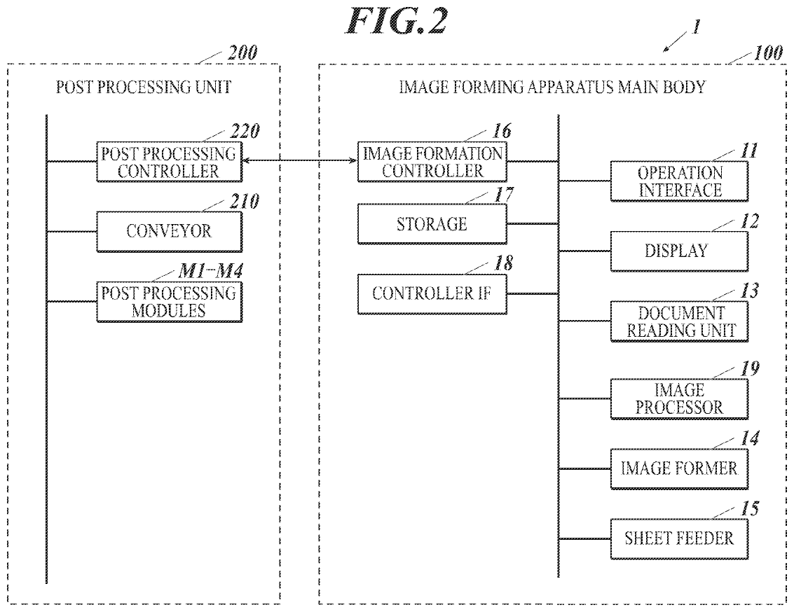

As illustrated in FIG. 1 and FIG. 2, the image forming apparatus 1 includes an image forming apparatus main body 100, a relay unit RU, a post processing unit 200 and a finisher FS.

The image forming apparatus main body 100 electrophotographically forms a color image based on image data that is obtained by reading an image of an original or received from an external device.

As illustrated in FIG. 1 and FIG. 2, the image forming apparatus main body 100 includes an operation interface 11, a display 12, a document reading unit 13, an image former (or an image forming device) 14, a sheet feeder 15, an image formation controller (hardware processor) 16, a storage 17, a controller IF (Interface) 18 and an image processor 19.

The operation interface 11 includes a touch panel covering a display screen of the display 12, number buttons, and various operation buttons such as a start button. The operation interface 11 outputs an operation signal to the image formation controller 16 based on a user operation.

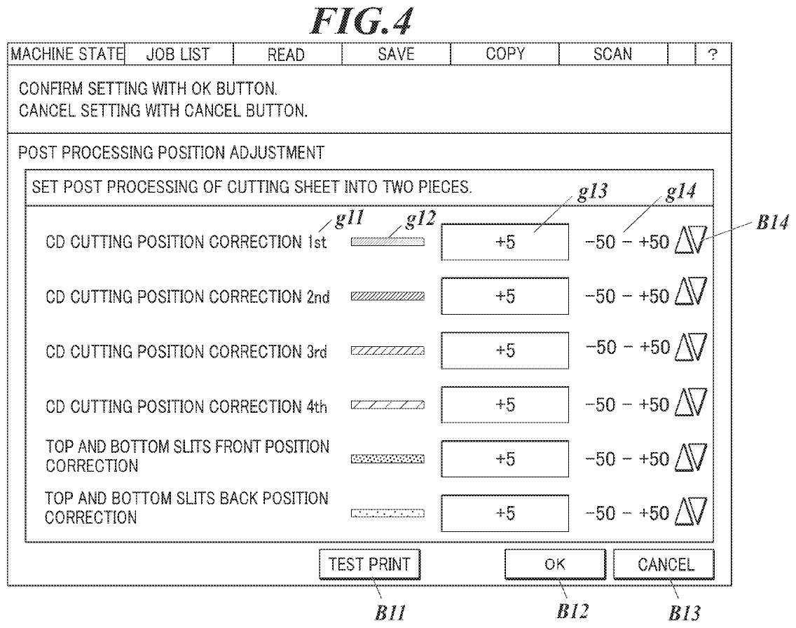

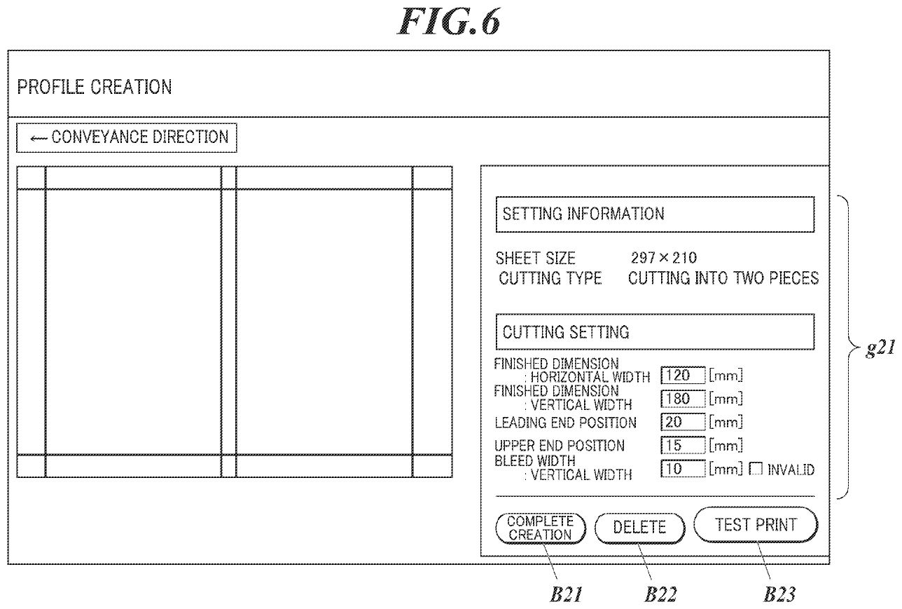

The operation interface 11 functions as a user adjuster. To be specific, the operation interface 11 is able to adjust (or receive a user operation to adjust) the values of a cutting position adjustment amount g13 and an input field g21 in a post processing position adjustment screen G1 (see FIG. 4) and a profile creation screen G2 (see FIG. 6) to be described later.

The display 12, which includes a liquid crystal display (LCD), displays various screens according to an instruction of a display signal from the image formation controller 16. For example, the display 12 displays the post processing position adjustment screen G1 (see FIG. 4) and the profile creation screen G2 (see FIG. 6)

The document reading unit 13, which includes an automatic document feeder (ADF), a scanner and the like, reads an image of an original to obtain image data and outputs the image data to the image formation controller 16.

The image former 14 forms an image on a sheet fed from the sheet feeder 15 based on image data that has been processed by the image processor 19.

The image former 14 includes photosensitive drums 141Y, 141M, 141C, 141K corresponding respectively to colors of yellow (Y), magenta (M), cyan (C) and black (K), an intermediate transfer belt 142, a secondary transfer roller 143, a fixer 144, a density sensor 145, a reverser 146, and the like.

The photosensitive drum 141Y is uniformly charged and thereafter scanned and exposed by a laser beam based on yellow image data so that an electrostatic latent image is formed. Then, yellow toner is allowed to attach to the electrostatic latent image on the photosensitive drum 141Y so that the image is developed.

The photosensitive drums 141M, 141C, 141K work similarly as the photosensitive drum 141Y except that the respective colors are different, and the description thereof is omitted.

The toner images formed on the photosensitive drums 141Y, 141M, 141C, 141K are sequentially transferred onto a rotating intermediate transfer belt 142 (primary transfer). That is, a color toner image in which toner images of four colors are superimposed is formed on the intermediate transfer belt 142.

The color toner image on the intermediate transfer belt 142 is collectively transferred onto a sheet by a secondary transfer roller 143 (secondary transfer).

The fixer 144 includes a heating roller for heating the sheet on which the color toner image has been transferred, and a pressure roller for pressing the sheet. The fixer 144 fixes the color toner image to the sheet by heat and pressure.

The reverser 146 includes a reversing path (switchback path) that reverses the sheet to which fixing has been performed by the fixer 144 and conveys the sheet to the secondary transfer roller 143. In the image forming apparatus 1, the sheet is reversed by the reverser 146 when the image formation is performed on both sides of the sheet. When the image formation is performed on only one side of the sheet, the sheet is conveyed to the relay unit RU without being reversed by the reverser 146.

The sheet feeder 15, which includes sheet feeding trays T11 to T13, feeds sheets to the image former 14. In each of the sheet feeding trays T11 to T13, sheets with predetermined sheet type and size are stored.

The image formation controller 16 includes a CPU, a ROM and a memory.

The CPU reads out various processing programs stored in the ROM and integrally controls the operation of the components of the image forming apparatus main body 100 according to the programs. When post processing is performed on an output sheet, the CPU outputs an instruction to the post processing unit 200 to execute predetermined post processing.

The ROM, which includes a non-volatile semiconductor memory and the like, stores various processing programs, parameters for executing the programs, files and the like.

The memory, which includes a dynamic random access memory (DRAM) and the like, temporarily stores various data such as programs and image data relating to various image processing.

When setting information of post processing which is included in the print job or setting information of post processing which was set by a user operation from the operation interface 11 is transmitted, the image formation controller 16 determines post processing to be executed at after-mentioned post processing modules M1 to M4 and finisher FS. The image formation controller 16 as a data generator generates adjustment image data corresponding to the determined post processing.

The image formation controller 16 as a controller causes the image former 14 to form an adjustment image based on the adjustment image data.

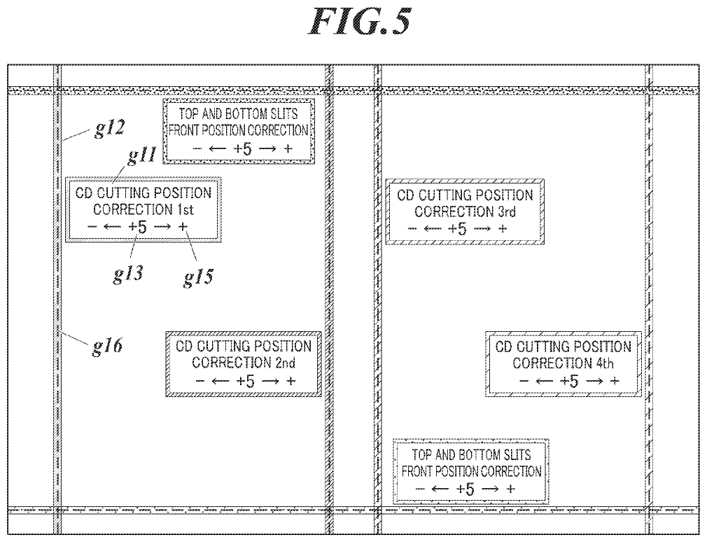

The adjustment image data is image data for forming the adjustment image that has identification information for individually identifying multiple adjustment items to post processing on the basis of the setting information of post processing performed to the sheet as shown in FIGS. 5 and 7 to 9 (at the time of cutting the sheet into two pieces).

The image formation controller 16 as a display controller causes the display 12 to display various screens. To be specific, for example, the image formation controller 16 causes the display 12 to display the post processing position adjustment screen G1 (see FIG. 4) for displaying the correspondence between adjustment items and setting values, the profile creation screen G2 (see FIG. 6) and the like.

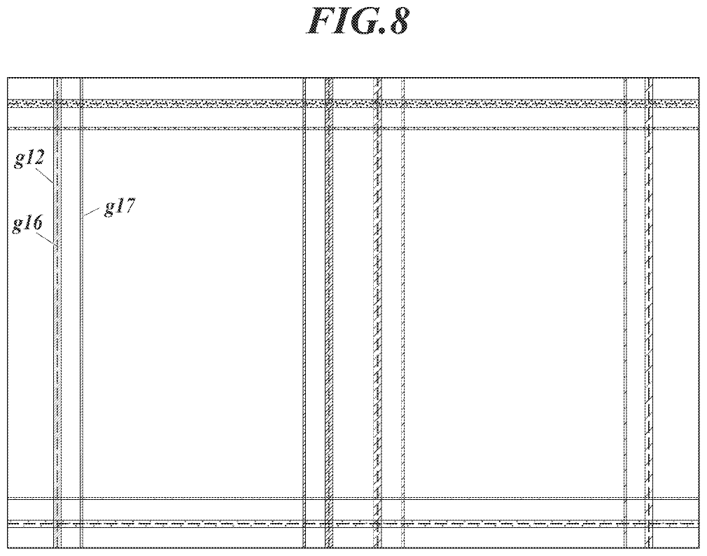

The image formation controller 16 as an automatic adjuster automatically measures and adjusts the error with respect to the setting value of the cutting position by scanning, with the document reading unit 13, the image (see FIG. 8) which is dedicated for automatic adjustment and has an auxiliary line g17 for adjusting the cutting position and the like that are together printed thereon.

The above auxiliary line g17 for adjusting the cutting position and the like are generated by the image formation controller 16.

The storage 17 is a non-volatile storage device such as a hard disk drive (HDD) or a semiconductor memory for storing various data such as programs and image data. The storage 17 stores data such as programs and various setting data in a manner readable and writable by the image formation controller 16. For example, the storage 17 stores profile data regarding the cutting.

The controller IF 18 receives image data input from an external device.

The image processor 19 performs necessary image processing on image data stored in the storage 17, image data obtained by the document reading unit 13 reading an image of an original, or image data input from an external device. The image processor 19 then sends the processed image data to the image former 14. Such image processing includes gradation processing, halftone processing, color conversion processing and the like. The gradation processing is to convert the gray level of each pixel in image data to a corrected gray level so that the density characteristic of the image to be formed on a sheet matches a desired density characteristic. The halftone processing is error diffusion processing, screen processing by ordered dithering or the like. The color conversion processing is to convert of RGB levels to CMYK levels.

The relay unit RU, which is disposed between the image forming apparatus main body 100 and the post processing unit 200, has a function of synchronizing with the conveyance speed of a sheet conveyed from the image forming apparatus main body 100.

The post processing unit 200 performs post processing on a sheet that is output from the relay unit RU, according to need. Examples of such post processing include slitting, bleed slitting, CD cutting, creasing, FD/CD perforating and the like. The post processing unit 200 performs post processing only when instructed by the image forming apparatus main body 100. When there is no post processing to be performed, the post processing unit 200 simply conveys the received sheet to the finisher FS.

As illustrated in FIG. 1 and FIG. 2, the post processing unit 200 includes a conveyer 210, post processing modules M1 to M4 (cutters), a purge tray T1 to which a sheet purged from the post processing unit 200 is ejected, a card tray T2 to which a sheet cut in the size of a business card or the like by the post processing unit 200 is ejected, and a post processing controller 220.

The conveyer 210 conveys a sheet received from the relay unit RU to the post processing modules M1 to M4. The conveyer 210 further conveys the sheet on which post processing has been performed in the post processing modules M1 to M4 to one of the trays (purge tray T1, card tray T2) or the finisher FS.

The conveyer 210 includes: a straight conveyance path 211 having a skew correcting function of correcting skew of a sheet heading to the post processing module M1; a long sheet unit 212 having a CD (sheet width direction) adjusting function of adjusting the position of a long sheet heading to the post processing module M1 in the sheet width direction by making the long sheet take a detour; a reverse ejection path 213 for reversing a sheet (up to regular size) after post processing by the post processing modules M1 to M4 and ejecting the reversed sheet to the finisher FS; a two-way path 214 that serves as a sheet ejection path for ejecting a sheet to the purge tray T1 as well as a reverse path for reversing the sheet (up to regular size); and a long sheet unit 215 as a reversing path for reversing a long sheet after post processing by the post processing modules M1 to M4.

The post processing modules M1 to M4 perform post processing on a received sheet. The post processing modules M1 to M4 perform post processing on a sheet when a part of the sheet is in a space path (the reverse sheet ejection path 213, the two-way path 214 or the long unit 215).

The post processing controller 220 includes a CPU, a ROM and a memory.

The CPU reads out various processing programs stored in the ROM and integrally controls the components of the post processing unit 200 according to the programs. For example, the CPU communicates with the image formation controller 16 of the image forming apparatus main body 100 and controls the post processing modules M1 to M4 to perform post processing based on a profile which was set in advance.

The finisher FS has a function of stapling, folding, punching, and the like for a sheet on which an image has been formed.

The post processing modules M1 to M4 and finisher FS function as a post processor (or a post processing unit).

[Operation]

Next, the operation of image forming apparatus 1 according to one or more embodiments will be described.

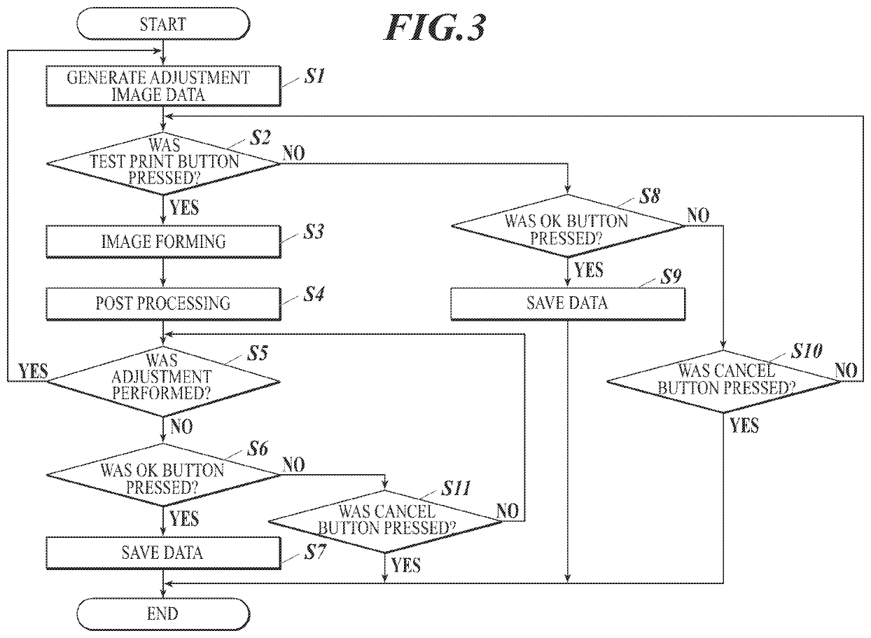

FIG. 3 is a flowchart showing the flow of operation executed by the image forming apparatus 1. This processing is executed in response to a trigger that the operation of instructing to start the post processing position adjustment has been performed via the operation interface 11 or the like. As an example of post processing, cutting a sheet into two pieces will be described.

When the processing starts, the image formation controller 16 first causes the display 12 to display the post processing position adjustment screen G1 (FIG. 4). The user can set the contents of the profile regarding cutting before executing the print job by using this screen.

The post processing position adjustment screen G1 shown in FIG. 4 is a screen mainly used by a serviceman that performs maintenance and the like of the image forming apparatus 1.

As shown in FIG. 4, on the post processing position adjustment screen G1 at the time of cutting the sheet into two pieces, a cutting type g11 (adjustment item), a line image g12 indicating the cutting position, a cutting position adjustment amount g13 (setting value), and a cutting position adjustable range g14 for each cutting type, a test print button B11 to perform test print, an OK button B12, a cancel button B13, cutting position adjustment buttons B14 and the like are displayed.

The line image g12 indicating the cutting position is shown by a different color for each cutting type g11.

When the test print button B11 is pressed, the image formation controller 16 causes the image former 14 to perform image formation based on the adjustment image data, and causes the post processing modules M1 to M4 and finisher FS to perform the post processing.

When the OK button B12 is pressed, the image formation controller 16 causes the storage 17 to save the various setting values regarding post processing as default setting.

When the cancel button B13 is pressed, the image formation controller 16 ends the processing without causing the storage 17 to save the various setting values regarding post processing as default setting.

When the cutting position adjustment button B14 is pressed, the image formation controller 16 increases/decreases the cutting position adjustment amount g13.

Thus, the operator can manually adjust the cutting position adjustment amount g13 by using the cutting position adjustment button B14 and the like on the post processing position adjustment screen G1 shown in FIG. 4.

As shown in FIG. 3, the image formation controller 16 generates adjustment image data for forming the adjustment image as shown in FIG. 5 on the basis of the setting information of the cutting position adjustment amount g13 shown in FIG. 4 via the operation interface 11 (step S1).

The adjustment image based on the adjustment image data generated in step S1 is displayed as a preview image on the display 12.

To be specific, for example, as shown in FIG. 5, the cutting position for each cutting type on the sheet is shown on the preview image of the cutting position at the time of cutting the sheet into two pieces displayed on the display 12 of the image forming apparatus main body 100. The dotted line shows each cutting position g16. On the dotted line, a thick line (line image g12 showing cutting position) of the color corresponding to the cutting type g11 is drawn as identification information.

Thus, it is easy to check, on the preview screen, which cutting position corresponds to which cutting type.

Since the identification information is shown by the thick line, when test print is performed and the sheet is cut, the color of thick line remains at each cutting position of cut piece and test print product, and it is easy to know which cutting position to adjust.

As the identification information, the cutting type g11, the cutting position adjustment amount g13 and the adjustment direction g15 may be displayed on the sheet. The color of frame surrounding the identification information may be the color of line image g12 showing the cutting position.

Thus, which cutting position should be adjusted can be easily known without referring to the setting screen (post processing position adjustment screen G1, after-mentioned profile creation screen G2). Furthermore, it is possible to recognize the quantitative cutting position adjustment amount at a glance.

If the test print button B11 shown in FIG. 4 is pressed via the operation interface 11 (step S2: YES), the image formation controller 16 causes the image former 14 to form the adjustment image on the sheet on the basis of the adjustment image data generated in step S1 (step S3).

Thereafter, the post processing modules M1 to M4 and finisher FS perform post processing on the sheet on which the image was formed in step S3 on the basis of the setting information of post processing (step S4).

The operator then checks the test print product and changes the setting values as needed.

If the setting values are not adjusted (step S5: NO), the image formation controller 16 determines whether the OK button B12 shown in FIG. 4 was pressed via the operation interface 11 (step S6).

If the image formation controller 16 determines that the OK button B12 shown in FIG. 4 was pressed via the operation interface 11 (step S6: YES), the image formation controller 16 saves various setting values regarding the post processing as default setting in the storage 17 (step S7), and the processing ends.

In step S2, if the test print button B11 shown in FIG. 4 is not pressed via the operation interface 11 (step S2: NO) but the OK button B12 is pressed (step S8: YES), the image formation controller 16 saves the various setting values regarding the post processing as the default setting in the storage 17 (step S9) and ends the processing.

In step S8, if the OK button B12 shown in FIG. 4 is not pressed (step S8: NO), but the cancel button B13 is pressed (step S10: YES), the image formation controller 16 ends the processing.

In step S10, if the cancel button B13 shown in FIG. 4 is not pressed (step S10: NO), the image formation controller 16 proceeds to step S2 again.

In step S5, if the cutting position adjustment amount g13 shown in FIG. 4 is adjusted via the operation interface 11 by the operator (step S5: YES), the image formation controller 16 proceeds to step S1 again.

In step S6, if the OK button B12 shown in FIG. 4 is not pressed (step S6: NO), and the cancel button B13 is pressed (step S11: YES), the image formation controller 16 ends the processing.

In step S11, if the cancel button B13 shown in FIG. 4 is not pressed (step S11: NO), the image formation controller 16 proceeds to step S5 again.

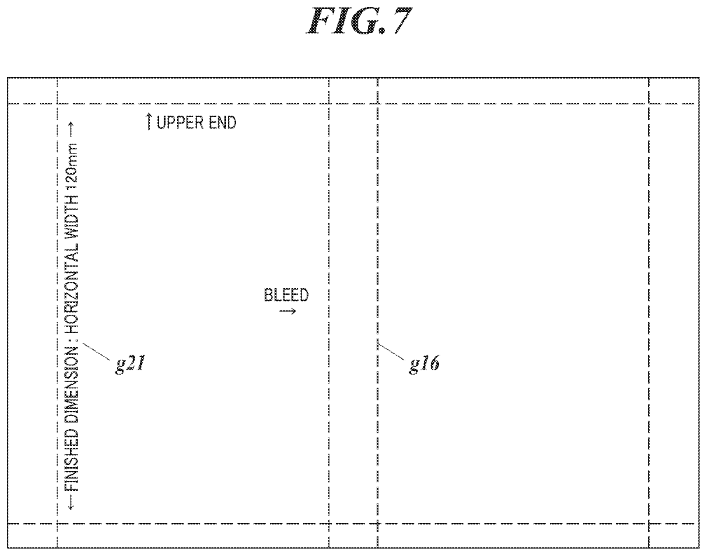

Next, the profile creation screen G2 (FIG. 6) and variations of preview image (FIGS. 7 to 9) will be described by using an example of a case where the post processing is cutting the sheet into two pieces.

As shown in FIG. 6, the profile creation screen G2 at the time of cutting the sheet into two pieces includes: an input field g21 for inputting data to setting items regarding the cutting; a creation completion button B21 for instructing completion of inputting data regarding each item; a delete button B22 for deleting input of data regarding each item; and a test print button B23 to perform test print. The set cutting positions and the like are displayed as an image IM resembling the sheet that is displayed in the left portion of the profile creation screen G2.

The profile creation screen G2 shown in FIG. 6 is a screen that is mainly used by the user. That is, the profile creation screen G2 is used when the user performs test printing. The profile creation screen G2 is used when the job to be printed is already created and then the user attempts to perform trial printing.

Thus, the serviceman performs default adjustment (adjustment in the post processing position adjustment screen G1), and each user can perform fine adjustment (adjustment in the profile creation screen G2).

In the above description of flowchart, the post processing position adjustment screen G1 shown in FIG. 4 is used. The flow when using the profile creation screen G2 shown in FIG. 6 is similar to the flow performed when using the post processing position adjustment screen G1 shown in FIG. 4. In the case of profile creation screen G2 (FIG. 6), the following matters are replaced.

(1) The operation of instructing to start the post processing position adjustment is replaced with the operation of instructing to start the profile creation.
(2) The cutting position adjustment amount g13 is replaced with the values of input field g21.
(3) The test print button B11 is replaced with the test print button B23.
(4) The OK button B12 is replaced with the creation completion button B21.
(5) The cancel button B13 is replaced with the delete button B22.

The image forming apparatus 1 of embodiments described above includes an image formation controller 16 that: generates adjustment image data including identification information for individually identifying multiple adjustment items for post processing performed on a sheet based on setting information of the post processing; and causes an image former 14 to form an adjustment image based on the adjustment image data on the sheet.

Thus, since the adjustment item is identified by checking identification information even after performing post processing, it is possible to facilitate checking the adjustment results to the post processing and facilitate the adjustment.

Furthermore, the identification information includes a line image of a different color for each of the adjustment items. Thus, the adjustment item can be identified by the color of line image, and it is possible to facilitate checking the adjustment results to the post processing and facilitate the adjustment.

Furthermore, the image formation controller 16 displays, on a display 12, a post processing position adjustment screen G1 and a profile creation screen G2 each as a setting screen that displays correspondence between the adjustment items and setting values.

Thus, since the correspondence between the adjustment items and the setting values can be known in the setting screen, it is possible to facilitate checking the adjustment results to the post processing and facilitate the adjustment.

Furthermore, the identification information includes a name of each adjustment item and the setting value. Thus, it is possible to more facilitate checking the adjustment results to the post processing and facilitate the adjustment.

Furthermore, the image forming apparatus 1 includes an operation interface 11 that adjusts the setting value by a user operation. Thus, the operator can easily perform desired adjustment. Alternatively, the image formation controller 16 can automatically adjust the setting value based on a preset condition.

Furthermore, the adjustment item is an item for which a post processing position is adjusted, and the adjustment image includes an image indicating an adjustment direction by increase and decrease of the setting value. Thus, it is possible to facilitate checking the adjustment results to the post processing and facilitate the adjustment.

Though the present invention has been specifically described on the basis of the embodiments, the present invention is not limited to the above embodiments, and modifications can be made within the scope of the invention.

For example, as shown in FIG. 7, the image formation controller 16 may generate adjustment image data showing the name of cutting type (value of input field g21) and the like near the cutting position g16.

Thus, the adjustment for each cutting type can be performed easily.

As shown in FIG. 8, the image formation controller 16 may generate the adjustment image data including the auxiliary line g17 for adjustment. When automatic adjustment is performed with a scanner or the like, the image dedicated for automatic adjustment may be printed.

Thus, it is possible to check the setting value and the value of actual cut and adjust the cutting position. To be specific, in a case of drawing the auxiliary line g17 to have a distance 2 cm away from the cutting position, the test print product is visually checked after test printing was performed. If there is an error not having the distance of 2 cm, it is possible to manually adjust the setting value. It is also possible to perform adjustment by scanning the image dedicated for automatic adjustment and automatically measure the error to the setting value.

To be specific, in step Si of the flowchart shown in FIG. 3, the image formation controller 16 can add the auxiliary line g17 for adjusting the cutting position (FIG. 8) to the adjustment image data.

In the case where the auxiliary line g17 for adjusting the cutting position (FIG. 8) is added to the adjustment image data in step S1, the following adjustments are also possible in step S5 of the flowchart shown in FIG. 3.

For example, the error to the setting value of the cutting position is automatically measured to perform adjustment by scanning, with the document reading unit 13, the test print product (see FIG. 8) dedicated for automatic adjustment on which the auxiliary line g17 for adjusting the cutting position and the like are printed together.

For example, the test print product (see FIG. 8) on which the auxiliary line g17 for adjusting the cutting position and the like are printed together are visually checked and the error to the setting value of the cutting position is manually adjusted.

The image formation controller 16 may generate image data obtained by overlaying the adjustment image data on the specified image data which was specified by the image formation controller 16, the user operation, or the like.

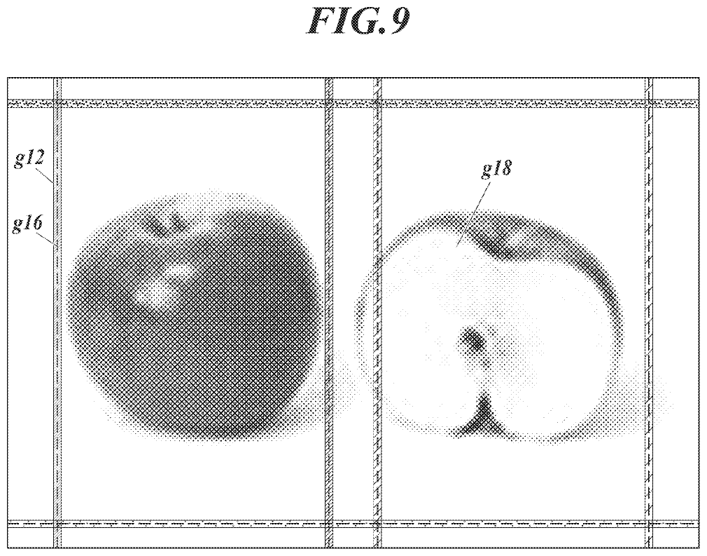

To be specific, as shown in FIG. 9, the image data is data of an image obtained by combining the line image g12 and cutting position g16 indicating the cutting position as the adjustment image based on the adjustment image data, with the image to be printed (image based on the specified image data) g18.

Thus, it is possible to easily perform adjustment by recognizing whether the cutting position overlaps the image or not and which type of cutting overlaps the image.

Instead of scanning, with the document reading unit 13, the image (see FIG. 8) dedicated for automatic adjustment on which the auxiliary line g17 for adjusting the cutting position and the like are printed together, a reading device may be provided to the conveyor 210 at a position after the post processing modules M1 to M4 and finisher FS so that the cutting position of sheet and the auxiliary line g17 and the like are automatically read and compared with the adjustment image data, and the error of the cutting position to the setting value is measured and adjusted.

The identification information may be shown by numbers. To be specific, No. 1 indicates the first time correction of CD cutting position, for example.

The type of line indicating the cutting position is not limited to the dotted line.

The thick line of the identification information may have any thickness as long as the cut piece and the test print product have thickness which can be visually checked after the cutting.

The identification information may be a mark corresponding to the cutting position of the cut piece and test print product. To be specific, a circle mark is printed around the cutting position of the cut piece and a circle mark is printed around the corresponding cutting position of the test print product. In this case, the dotted line indicating each cutting position may be on ends of the thick line since it is not necessary to leave the color of thick line indicating the cutting position on the cut piece and the test print product.

For example, the portion corresponding to the cut piece discarded by the cutting may be excluded from the target of printing. Accordingly, the identification information is not printed on the cut piece discarded by the cutting, which facilitates checking the adjustment results to the post processing and facilitates the adjustment.

The above embodiments show an example of cutting the sheet into two pieces. However, the present invention can be applied to quadruple cutting, multiple cutting, business card size cutting and the like.

The identification information is not limited to one cutting position. To be specific, in the case of moving two cutting positions by one parameter (one side fixed, adjustment by width, and the like), same identification information may be provided to two cutting positions.

Though identification information indicates the cutting position in the above embodiments, the identification information is not limited to the cutting position. To be specific, the identification information may indicate positions of stapling, punching and the like.

Though the above embodiments have a configuration including the image formation controller 16 and the post processing controller 220, one of them may control the entire image forming apparatus 1.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image forming apparatus comprising:
an image former that forms an image on a sheet; and
a hardware processor that:
generates, based on setting information of post processing performed on the sheet, adjustment image data that includes identification information identifying each of a plurality of adjustment items of the post processing; and
causes the image former to form, based on the adjustment image data, an adjustment image on the sheet.

2. The image forming apparatus according to claim 1, wherein the identification information includes a line image of a different color for each of the adjustment items.

3. The image forming apparatus according to claim 1, wherein the hardware processor displays, on a display, a setting screen that displays a correspondence between a setting value and each of the adjustment items.

4. The image forming apparatus according to claim 3, wherein the identification information includes the setting value and a name of each of the adjustment items.

5. The image forming apparatus according to claim 3, further comprising:
an operation interface that receives a user operation to adjust the setting value.

6. The image forming apparatus according to claim 3, wherein the hardware processor automatically adjusts the setting value based on a preset condition.

7. The image forming apparatus according to claim 5, wherein the hardware processor generates the adjustment image data that includes an auxiliary line for adjusting the setting value.

8. The image forming apparatus according to claim 1, wherein
the post processing includes cutting, and
the hardware processor generates the adjustment image data that includes the identification information formed on a portion of the sheet excluding a portion corresponding to a cut piece to be discarded by the cutting.

9. The image forming apparatus according to claim 3, wherein
each of the adjustment items is for adjusting a post processing position, and
the adjustment image includes an image indicating a direction of increasing or decreasing the setting value.

10. The image forming apparatus according to claim 1, wherein the hardware processor generates image data by overlaying the adjustment image data on specified image data.

11. The image forming apparatus according to claim 1, further comprising:
a post processor that performs the post processing on the sheet on which the image former forms the adjustment image.

12. A non-transitory computer readable storage medium storing a program that causes a computer of an image forming apparatus including an image former to execute:
generating, based on setting information of post processing performed on a sheet, adjustment image data that includes identification information identifying each of a plurality of adjustment items of the post processing; and
causing the image former to form, based on the adjustment image data, an adjustment image on the sheet.
